(19) United States
(12) Patent Application Publication
(10) Pub. No.: US 2003/0029721 A1
(43) Pub. Date: Feb. 13, 2003

(54) Electrochemical sensor with baffle and associated methods

(76) Inventors: Stephen H. Broy, Riverside, CA (US); Michael A. Gonzalez, Pomona, CA (US)

Correspondence Address: KIRKPATRICK & LOCKHART LLP, 535 SMITHFIELD STREET, PITTSBURGH, PA, 15222, US

(21) Appl. No.: 09/924,009

(22) Filed: Aug. 7, 2001

(51) Int. Cl. G01N 27/26

(52) U.S. Cl. 204/400; 204/431

(57) ABSTRACT

An electrochemical gas sensor. One embodiment of the sensor may include a sensor body having a cavity, an electrolyte solution in the cavity, an auxiliary electrode in contact with the electrolyte solution, a sensing electrode in contact with the electrolyte solution, and a first baffle mounted within the cavity. The baffle comprises a plate with at least one aperture and serves to form a partial barrier for delaying the mixing process when liquid is added to the electrolyte solution. The sensor may also include a second such baffle. Also a method for mixing a liquid with electrolyte solution of an electrochemical sensor. The method includes forming a first barrier within the cavity and controlling the flow of the liquid introduced through the first barrier. The method may include forming a second such barrier and controlling the flow of the liquid through the first and second barriers.

### BACKGROUND OF THE INVENTION

1. Field of the Invention

The present invention relates to electrochemical sensors and, more particularly, to electrochemical sensors that include one or more baffles, and associated methods.

2. Description of the Invention Background

Electrochemical gas sensors are used to sense a target gas content of a sample gas. Typical electrochemical sensors include a sensing electrode (cathode) and an auxiliary or counter electrode (anode) disposed in an electrolyte solution contained within a sensor body (cell). An oxygen sensor using additional electrodes, including a blocking electrode and a reference electrode is described in U.S. Pat. No. 6,176,989, which is incorporated herein by reference.

A problem exists for a certain class of electrochemical oxygen sensors that require periodic addition of water to the electrolyte solution. The sample gas is typically devoid of water and tends to draw water out of the electrolyte solution by the process of evaporation or diffusion. Consequently, the density of the electrolyte solution increases over time. To maintain a proper concentration in the electrolyte solution, water must be added periodically to replenish the water that is evaporated from the electrolyte solution or diffused through a gas diffusion sensing electrode. When water is added to the electrolyte solution, the chemistry of the sensor is altered rendering the readings of the sensor inaccurate until a new equilibrium level is reached in the electrolyte solution. The stabilization process can take in excess of a day, resulting in significant downtime, often during a critical stage of the manufacturing process that requires quality control of a gas being delivered or received, such as in semiconductor manufacturing processes. Alternatively, a back up sensor must be used during this period.

There remains, therefore, a need for an electrochemical sensor with features that overcome the limitations, shortcomings and disadvantages of other electrochemical sensors without compromising their performance.

### SUMMARY OF THE INVENTION

One embodiment of the invention is directed to an electrochemical sensor that has a body with an interior cavity containing an electrolyte solution. The sensor includes a sensing electrode and an auxiliary electrode in contact with the electrolyte solution. The sensor also includes a first baffle mounted within the cavity and having at least one aperture therethrough. The baffle may control the flow of a liquid added to the cavity into the electrolyte solution. In other embodiments, the baffle may also comprise a plate with two apertures, or a plate with a plurality of apertures. The sensor may include a second baffle having at least one aperture and mounted between the first baffle and the auxiliary electrode.

Another embodiment of the inventrion is directed to an electrochemical sensor that has a body with an interior cavity containing an electrolyte solution. The sensor includes a sensing electrode and an auxiliary electrode in contact with the electrolyte solution, and a first plate supported within the cavity and having at least one aperture such that a liquid added to the electrolyte solution must pass through the aperture(s) before mixing with the electrolyte solution. The sensor may include a second such plate mounted below the first plate.

Yet another embodiment is directed to an electrochemical oxygen sensor that comprises a sensor body having a cavity; and an electrolyte solution in the cavity, an auxiliary electrode and a sensing electrode in contact with the electrolyte solution, and a first plate having a first aperture therethrough and being supported in the cavity to form a first partial barrier above the auxiliary electrode for controlling flow of a liquid into the electrolyte solution when the liquid is added to the cavity above the first plate. The sensor may include a second plate having at least one aperture therethrough and being supported in the cavity between the first plate and the auxiliary electrode.

Another embodiment of the invention is directed to a baffle for an electrochemical sensor having a body with an interior cavity containing electrolyte solution. The baffle comprises a plate mounted within the cavity and having at least one aperture for controlling the flow of a liquid added to the cavity into the electrolyte solution.

Another embodiment of the invention is directed to a method of mixing a liquid with an electrolyte solution contained within a cavity formed in a body of an electrochemical sensor. One embodiment of the method includes forming a first barrier or baffle within the cavity below a location within the cavity wherein the liquid is introduced, introducing the liquid into the cavity and controlling the flow of the liquid introduced through the first barrier by providing at least one first aperture through the first barrier prior to introducing the liquid. The method may also include forming a second barrier within the cavity below the first barrier and controlling flow of the liquid through the first and second barriers prior to introducing the liquid.

The present invention may be advantageously used in many applications, including any type of electrochemical sensor in which the electrolyte solution is refillable or needs to be replenished.

One feature of an embodiment of the present invention is to provide a mechanical baffle for an electrochemical sensor that allows replenishing the electrolyte solution of the sensor with little, if any, disturbance to the readings of the sensor, by providing controlled mixing through the gradual introduction of a liquid additive.

Another feature of an embodiment of the baffle used in the invention is that it is simple to manufacture, requires little regular maintenance in operation, has an extended useful life, improves the performance of the electrochemical sensor in which it is installed by minimizing downtime during replenishment of the electrolyte solution and eliminates the need of keeping back-up sensors.

Another feature of an embodiment of the baffle used in the invention is that it is versatile and may be easily adapted to control the speed of the mixing process of a liquid additive to the electrolyte.

Other features and advantages of the invention will become apparent from the detailed description of the preferred embodiments and from the claims.

### BRIEF DESCRIPTION OF THE DRAWINGS

FIG. 1 is a sectional view of an embodiment of an electrochemical gas sensor of the present invention employing an embodiment of a baffle of the present invention;

FIG. 2 is a top view of an embodiment of a baffle of FIG. 1 according to the invention;

FIG. 3 is a top view of another embodiment of a baffle of FIG. 1 according to the invention; and

FIG. 4 is a top view of another embodiment of a baffle of FIG. 1 according to the invention.

### DETAILED DESCRIPTION OF THE INVENTION

Referring now to the drawings for the purpose of illustrating the invention and not for the purpose of limiting the same, it is to be understood that standard components or features that are within the purview of an artisan of ordinary skill and do not contribute to the understanding of the various embodiments of the invention are omitted from the drawings to enhance clarity, even when such features may otherwise be necessary for the function of an electrochemical sensor embodying the invention. In addition, it will be appreciated that the characterizations of various components, such as electrodes, vents or inlets, described herein as being vertical or horizontal or placed above or below other components, are relative characterizations only based upon the particular position or orientation of a given component for a particular application. It is also to be understood that the embodiments of the present invention that are described herein are illustrative only and are not exhaustive of the manners of embodying the present invention. For example, it will be recognized by those skilled in the art that the present invention may be readily adapted to function in conjunction with other sensors that operate on different principle, but which require periodic addition of a liquid, such as water, to restore the density or concentration or amount of the electrolyte solution in the sensor.

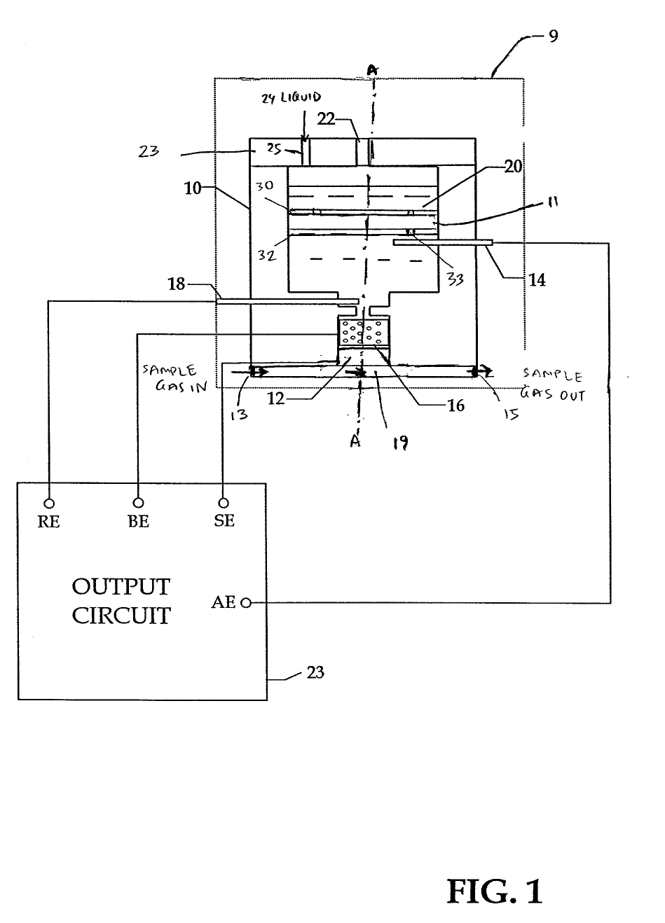

FIG. 1 is a sectional view of an electrochemical oxygen gas sensor 9 constructed according to the present invention and including a sensor body 10, a sensing electrode 12, an auxiliary electrode 14, an electrolyte solution 20 and a first baffle 30. The sensing 12 and auxiliary 14 electrodes are placed in contact with the electrolyte solution 20 that is contained in an interior cavity 11 of the sensor body 10. The electrolyte solution 20 may be an ionic conductor appropriate for the sensor operation. In this embodiment, the first baffle 30 is press-fitted into the cavity 11 of the sensor body 10 at a position intermediate between the top of the sensor body 10 and the auxiliary electrode 14, (above the auxiliary electrode 14) Other methods may also be used to support the baffle 30 within the cavity 11 of the sensor body 10, such as by molding, gluing or other suitable fasteners, or constructing the first baffle 30 as an integral part of the body 10.

The baffle 30 may be positioned inside the cavity 11 of the sensor body 10 such that it is substantially perpendicular to a longitudinal axis A-A of the sensor 9. See FIG. 1. Initially, the baffle 30 may be submerged in the electrolyte solution 20, but the level of the electrolyte solution 20 may drop below the baffle 30, when the electrolyte solution is gradually depleted through evaporation or diffusion of some of its water content.

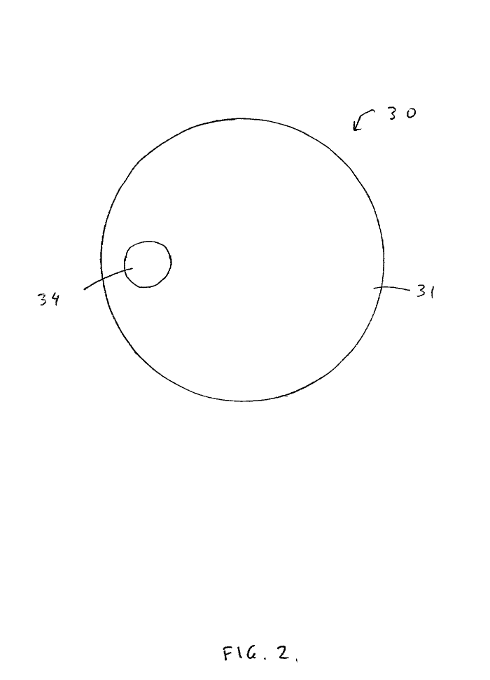

In this first embodiment, the first baffle 30 comprises a first plate 31 sized and shaped to fit closely into the cavity 11. That is, when supported within the cavity 11, the outer perimeter of the baffle 30 contacts the inner wall of the sensor body 10 such that there is no space between the outer perimeter of the first baffle 30 and the inner wall of the sensor body 10. As can be seen in FIG. 2, a first aperture 34 is provided through the baffle 30. The diameter of the first aperture 34 is such that, when a liquid additive or water or other liquid 24 is added to the cavity 11 to replenish a partially depleted electrolyte solution, the mixing process of the added liquid with the electrolyte solution 20 occurs gradually by flow transfer through the first aperture 34. We have discovered that such arrangement effectively prevents the added liquid from kinetic and Brownian mixing with the electrolyte solution 20.

The baffle 30 acts as a partial barrier to mixing, while allowing limited transfer of liquid. Consequently, sudden fluctuations of the chemistry or composition of the electrolyte solution are prevented, and the reliability of the sensor readings after addition of the liquid is maintained without any prolonged periods for stabilization, as is typically the case when liquid is added in prior art sensors that lack the benefit of the intervening baffle of the present invention.

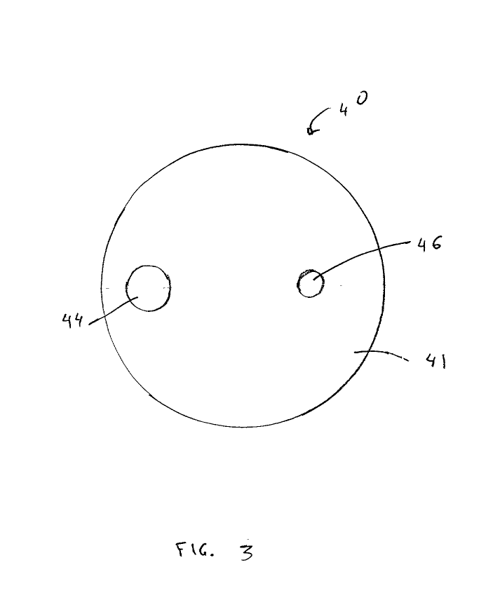

In another embodiment, shown in FIG. 3, the first baffle 40 may include a first aperture 44 and a second aperture 46 in a plate 41. The diameter of the second aperture 46 may be the same size or smaller than the diameter of the first aperture 44. The relative sizes of the apertures 44 and 46 for optimal delayed mixing are determined in conjunction with the size of the plate 41. For a plate with diameter 2.5 inches, for example, the first aperture 44 may be a circular hole with diameter ¼ inch and the second aperture 46 may be a hole with diameter 3/16 inch. However, other hole sizes may be similarly employed depending upon the amount of water to be added and the rate at which it is added.

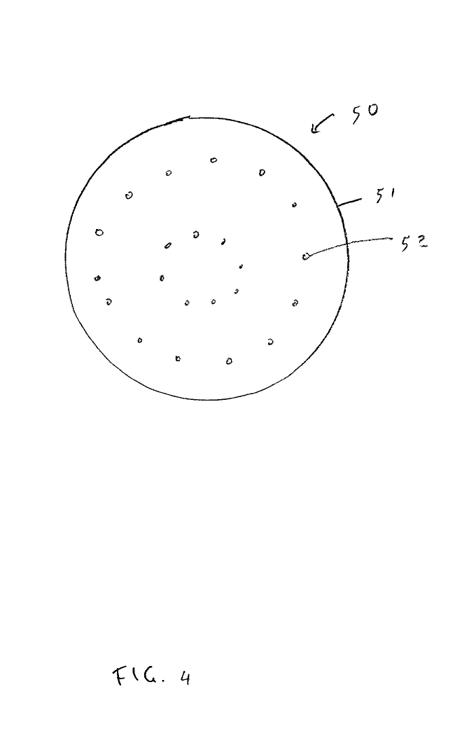

In yet another alternative embodiment, shown in FIG. 4, a baffle 50 comprises a plate 51 with a plurality of small apertures 52. The apertures 52 may be positioned on the plate 51 uniformly, randomly or in one or more concentric circles. In this embodiment, the gradual mixing of a liquid added to the electrolyte 20 occurs by restricting the size of the apertures 52 and increasing their number.

In another embodiment of the sensor 9, a second baffle 32, shown in FIG. 1, may be placed under the first baffle 30. The second baffle 32 may have at least one aperture 33, and may include the same or different number and sizes of the apertures. The aperture locations may be the same as in the first baffle of embodiments 30, 40 or 50. The baffles 30, 40, 50 and 32 may be formed from electrically insulating material, such as, for example, plastic or translucent acrylic.

Generally the baffle 30 can be any perforated plate 31 mounted within the cavity 11 such that it forms a partial barrier to control or graduate and delay the process of mixing one liquid that with another liquid contained in the cavity 11.

When some of the water in the electrolyte solution 20 is depleted over time through evaporation, diffusion or absorption by the sample gas, the level of the electrolyte solution 20 in the cavity 11 drops and it must be replenished periodically when it reaches too high concentration or a low level, such as, for example, when the electrolyte solution 20 falls to the level of the auxiliary electrode 14. Water 24, or other liquid additive as appropriate for the particular application, may then be added from a position above the first baffle 30, for example through an inlet 25. In some applications, the sensor 9 includes a cap 23, which may be removed to add water 24 to the electrolyte 20 as needed. The added water may reach the electrolyte solution 20 and mix with it only by passing through the first baffle 30 and, depending on the electrolyte level, the second baffle 32, if a second baffle 32 is installed.

Since the water has to seep through the respective apertures of the baffles, such as apertures 34, 44, 46 or 52, depending on the embodiment of the baffle, the mixing process is gradual and may be controlled by selecting the number, size and location of apertures. Additionally, a variety of baffles with different aperture configurations, such as 30 or 40 or 50 may be kept at hand and inserted into or removed from the sensor 9 as needed. By controlling the number of baffles and /or the configuration, number and sizes of apertures, the speed of the mixing process of the liquid additive, such as water, to the electrolyte solution 20 can be controlled.

The sensor 9 may also include a blocking electrode 16 and a reference electrode 18 in contact with the electrolyte solution 20. The blocking electrode 16 intercepts and reduces dissolved oxygen contained in the electrolyte solution 20 from the auxiliary electrode 14 and the atmosphere above the electrolyte solution 20, and it may also inhibit the sensing electrode 12 from sensing impurities in the electrolyte solution 20. The reference electrode 18 allows accurate control of the sensing electrode 12 potential by minimizing its polarization. A sample gas, which may include oxygen (the target gas), is brought in contact with the sensing electrode 12 as it enters through a sample gas inlet port 13 and exits through a sample gas outlet port 15. Some of the oxygen reacts on the sensing electrode 12 surface as the sample gas travels through the sample gas cavity 19. A very small amount of oxygen dissolves in the electrolyte solution 20 where the blocking electrode 16 reacts with it, but most of oxygen exits with the sample gas through the outlet gas port 15 of the sensor 9.

The components of the sensor 9 may be constructed from a variety of materials and in many dimensions. The materials and dimensions of the sensor 9 are illustrative only and are not exhaustive of the manners of embodying the present invention. A portion of each electrode 12, 14, 16, and 18 may extend through the sensor body 10 for connection to external circuitry. The body 10 may include a small vent, such as vent 22, to relieve internal pressure. The sensor body 10 itself may be formed from an electrically insulating material such as, for example, plastic. The vent 22, if suitably sized and removable, may also function as an inlet for adding water in lieu of inlet 25.

The electrolyte solution 20 may be any substance that provides the appropriate ionic conductivity consistent with the reduction/oxidation processes chosen for the sensing of the target gas at the sensing electrode 12. For example, potassium hydroxide based electrolyte solutions are suitable when oxygen is the target gas. Suitable electrolytes for sensing a particular target gas will be readily apparent to those of ordinary skill in the art.

The sensing electrode 12 is disposed within the body 10 such that it is in contact with both the electrolyte solution 20 and the sample gas. Candidates for the sensing electrode 12 include, for example, the gas diffusion electrode of sensor 9 or a noble metal electrode covered with a gas permeable, hydrophobic membrane. In these embodiments, it may be advantageous to construct the sensing electrode 12 from materials that are relatively chemically inert, for example, carbon, silver, gold, and platinum. As used herein, the term “chemically inert” refers to materials that do not readily react with other materials, whether in gaseous, liquid, or solid form, that will be encountered during the operation of the sensor 9 and under conditions in which the sensor 9 is to be used.

When the sensing electrode 12 is appropriately biased with respect to the electrolyte solution 20, the target gas will be reduced (or oxidized depending on the design of the electrochemical sensor). In the case of an oxygen sensor, oxygen from the gas sample is reduced at the sensing electrode 12 when the sensing electrode 12 is biased at a potential of −0.7 to −1.0 volt producing a current associated with the reduction of oxygen that is directly proportional to the pressure of oxygen in the sample gas.

The electrodes 12, 14, 16, and 18 of the present invention are typically connected to an output circuit 23, at terminals SE, AE, BE, and RE respectively. The output circuit 23 permits interaction between the electrodes 12, 14, 16, and 18, and provides electrical output signals, corresponding to attributes sensed by the sensor 9, that may be read by external means.

For details of the function and construction of the blocking electrode 16 and the reference electrode 1, as well as the overall operation of the sensor 9, reference is made to U.S. Pat. No. 6,176,989, the entire contents of which are herein incorporated by reference. However, other variations of geometry, electrode materials, and electrolytes will be readily apparent to those of ordinary skill in the art on considering the present detailed description of the invention.

Another embodiment of the invention is directed to a method of mixing a liquid 24 with an electrolyte solution 20 contained within a cavity 11 formed in a body 10 of an electrochemical sensor 9. One embodiment of the method includes forming a first barrier or baffle 30 within the cavity 11 below a location within the cavity 11 wherein the liquid 24 is introduced, introducing the liquid 24 into the cavity 11 and controlling the flow of the liquid 24 introduced through the first barrier 30 by providing, for example, at least one first aperture 34 through the first barrier 30 prior to introducing the liquid 24. The method may also include forming a second barrier 32 within the cavity 11 below the first barrier 30 and controlling the flow of the liquid 24 through the first 30 and second 32 barriers prior to introducing the liquid 24.

Whereas particular embodiments of the invention have been described herein for the purpose of illustrating the invention and not for the purpose of limiting the same, it will be appreciated by those of ordinary skill in the art that numerous variations of the details, materials, processes and arrangement of parts may be made within the principle and scope of the invention without departing from the invention as described in the appended claims.

What is claimed is:

1. An electrochemical sensor comprising:
a sensor body having a cavity;
an electrolyte solution in the cavity;
an auxiliary electrode in contact with the electrolyte solution;
a sensing electrode in contact with the electrolyte solution; and
a baffle mounted within the cavity at a location above the auxiliary electrode, the baffle having at least one aperture therethrough.

2. An electrochemical sensor comprising:
a sensor body having a cavity;
an electrolyte solution in the cavity;
an auxiliary electrode in contact with the electrolyte solution;
a sensing electrode in contact with the electrolyte solution; and
a baffle plate mounted within the cavity and having a first aperture therethrough for controlling flow of a liquid added to the cavity into the electrolyte solution.

3. The electrochemical oxygen sensor of claim 2, wherein the baffle plate has a second aperture therethrough.

4. An electrochemical oxygen sensor comprising:
a sensor body having a cavity;
an electrolyte solution in the cavity;
an auxiliary electrode in contact with the electrolyte solution;
a sensing electrode in contact with the electrolyte solution; and
a first plate having a first aperture therethrough and being supported in the cavity to form a first partial barrier above the auxiliary electrode for controlling flow of a liquid into the electrolyte solution when the liquid is added to the cavity above the first plate.

5. The electrochemical oxygen sensor of claim 4, wherein the first plate has a second aperture therethrough.

6. The electrochemical oxygen sensor of claim 4, wherein the first plate is press fitted into the cavity.

7. The electrochemical oxygen sensor of claim 4, further including an inlet in the sensor body for adding the liquid to the electrolyte solution.

8. The electrochemical oxygen sensor of claim 7, wherein the first plate is positioned in the cavity between the inlet and the auxiliary electrode.

9. The electrochemical oxygen sensor of claim 4, wherein the sensor body has a longitudinal axis and the first plate is perpendicular to the longitudinal axis.

10. The electrochemical oxygen sensor of claim 4, further comprising a second plate having at least one aperture therethrough and being supported in the cavity between the first plate and the auxiliary electrode.

11. The electrochemical oxygen sensor of claim 4, wherein the first plate comprises acrylic material.

12. The electrochemical oxygen sensor of claim 4, wherein the first plate includes at least two apertures.

13. The electrochemical oxygen sensor of claim 4, wherein the liquid comprises water.

14. The electrochemical oxygen sensor of claim 4, further comprising an output circuit coupled to the sensing electrode.

15. The electrochemical oxygen sensor of claim 4, wherein the sensing electrode comprises a gas diffusion electrode.

16. An electrochemical sensor comprising:
a sensor body having a cavity;
an electrolyte solution in the cavity;
an inlet in the sensor body for adding liquid to the electrolyte solution
an auxiliary electrode in contact with the electrolyte solution;
a sensing electrode in contact with the electrolyte solution; and
means for controlling flow of a liquid into the electrolyte solution when the liquid is admitted through the inlet.

17. An electrochemical sensor comprising:
a sensor body having a cavity;
an electrolyte solution in the cavity;
an auxiliary electrode in contact with the electrolyte solution;
a sensing electrode in contact with the electrolyte solution; and
a first plate supported within the cavity and having at least one aperture such that a liquid added to the electrolyte solution must pass through the at least one aperture before mixing with the electrolyte solution.

18. The electrochemical sensor of claim 17, further comprising a second plate supported within the cavity and having a second at least one aperture such that the liquid added to the electrolyte solution must also pass through the second at least one aperture before mixing with the electrolyte solution.

19. A baffle for an electrochemical sensor having a body with an interior cavity containing electrolyte solution, the baffle comprising a plate mountable within the cavity, the plate having a size and shape corresponding to a size and shape of the interior cavity and having at least one flow control aperture therethrough.

20. The baffle of claim 19, further comprising at least two apertures therethrough the plate.

21. A baffle for an electrochemical sensor having a body with an interior cavity containing electrolyte solution, the baffle comprising a perforated plate mounted within the cavity such that the baffle forms a partial barrier within the interior cavity for controlling flow of a liquid into the electrolyte solution when the liquid is added to the interior cavity above the perforated plate.

22. The baffle of claim 21, wherein the perforated plate includes perforations that are uniformly distributed on the plate.

23. The baffle of claim 22, wherein the perforated plate includes perforations that are distributed along one or more concentric circles on the plate.

24. A baffle for an electrochemical sensor having a body with an interior cavity containing electrolyte solution, the baffle comprising a plate mounted within the cavity and having at least one aperture that provides controlled mixing of a liquid added to the electrolyte solution by the gradual introduction of the liquid to the electrolyte solution.

25. A method of mixing a liquid with an electrolyte solution contained within a cavity formed in a body of an electrochemical sensor, the method comprising:
forming a first barrier within the cavity below a location within the cavity wherein the liquid is introduced;
introducing the liquid into the cavity; and
controlling flow of the liquid introduced through the first barrier.

26. The method of claim 25, wherein controlling comprises providing at least one first aperture through the first barrier prior to said introducing.

27. The method of claim 25 further comprising;
forming a second barrier within the cavity below the first barrier;
and controlling flow of the liquid through the first and second barriers prior to said introducing.

28. The method of claim 27 wherein said controlling flow of the liquid through the first and second barrier comprises:
providing at least one first aperture through the first barrier prior to said introducing; and
providing at least one second aperture through the second barrier prior to said introducing
